(19) United States
(12) Patent Application Publication
(10) Pub. No.: US 2016/0296076 A1
(43) Pub. Date: Oct. 13, 2016

(54) Grabbing Device for Beverage Container Lids

(71) Applicant: John Antignane, Arlington, TN (US)

(72) Inventor: John Antignane, Arlington, TN (US)

(21) Appl. No.: 15/093,573

(22) Filed: Apr. 7, 2016

Related U.S. Application Data
(60) Provisional application No. 62/145,129, filed on Apr. 9, 2015.

(51) Int. Cl. A47J 47/16; F16M 11/22; B25J 15/00; F16B 1/00

(52) U.S. Cl. CPC A47J 47/16; F16B 1/00; F16M 11/22; B25J 15/0038; F16B 2001/0028; F16B 2001/0035

(57) ABSTRACT

A grabbing device for beverage container lids is utilized to prevent contact between a beverage container lid and a potentially contaminated surface such as the user's skin or a counter surface. An open end of a hollow shell is lowered onto a stack of beverage container lids and at least one beverage container lid is held in place within the hollow shell via friction. The hollow shell may then be lowered over a beverage container in order to engage the beverage container lid to the beverage container. The hollow shell may be tapered to accommodate a single lid or cylindrical to accommodate multiple lids. The hollow shell may be utilized in conjunction with a holding stand that serves to elevate the hollow shell in a position away from contaminated surfaces.

The current application claims a priority to the U.S. Provisional Patent application Ser. No. 65/145,129 filed on Apr. 9, 2015.

### FIELD OF THE INVENTION

The present invention relates generally to a device for improving the sanitation of beverage container lids. More specifically, the present invention is a grabbing device for beverage container lids that is utilized to prevent contact between a beverage container lid and the user's skin as well as any potentially contaminated surfaces.

### BACKGROUND OF THE INVENTION

Coffee and other beverages commonly served in coffee shops and similar establishments are often served in a disposable Styrofoam cup that is covered with a lid. In these establishments, coffee is typically prepared and served by employees or staff and not directly by the customer. As a result, it is common for employees to feel rushed when serving customers, particularly during busy times. A lid is typically attached to a coffee cup by manually engaging the lid onto the upper lip of the cup and depressing the lid in order to form a seal between the lip and the lid. This work is often performed by an employee or staff member who may be responsible for a number of additional tasks. For example, the employee or staff member may be required to handle cash or clean a dirty counter surface with a rag in between serving customers. An employee or staff member who feels rushed performing his or her duties may be more likely to ignore sanitation standards. As a result, customers often notice the unsanitary conditions under which their beverages are being prepared. This is undesirable for obvious reasons as drinking a beverage from a container lid that is known to be unsanitary is an unpleasant experience. Additionally, placing the mouth on a container lid that is potentially contaminated with bacteria may result in illness.

The present invention is a grabbing device for beverage container lids that is utilized to prevent contact between a beverage container lid and the user's skin as well as any potentially contaminated surfaces. The present invention serves as a barrier and additionally is utilized to hold and place a lid onto a beverage container.

### BRIEF DESCRIPTION OF THE DRAWINGS

FIG. 1 is a top perspective view of a single lid embodiment of the present invention.

FIG. 2 is a bottom perspective view of the single lid embodiment of the present invention.

FIG. 3 is a front view of the single lid embodiment of the present invention.

FIG. 4 is a cross-sectional view of the single lid embodiment of the present invention taken along line A-A of FIG. 3.

FIG. 5 is a front view of an alternately-sized embodiment of the present invention.

FIG. 6 is a front view of the single lid embodiment of the present invention with at least one lid-gripping feature and at least one hand grip.

FIG. 7 is a cross-sectional view of the single lid embodiment of the present invention with at least one lid-gripping feature and at least one hand grip taken along line B-B of FIG. 6.

FIG. 8 is a front view of a multiple lid embodiment of the present invention.

FIG. 9 is a cross-sectional view of the multiple lid embodiment of the present invention taken along line C-C of FIG. 8.

FIG. 10 is a perspective view of the present invention in use with the holding stand.

FIG. 11 is an exploded perspective view of the present invention in use with the holding stand utilizing the plurality of loop fasteners and the plurality of hook fasteners.

FIG. 12 is a perspective view of the present invention in use with the holding stand utilizing the first magnet and the second magnet.

FIG. 13 is a front exploded view of the present invention in use with the holding stand utilizing the first magnet and the second magnet.

### DETAIL DESCRIPTIONS OF THE INVENTION

All illustrations of the drawings are for the purpose of describing selected versions of the present invention and are not intended to limit the scope of the present invention.

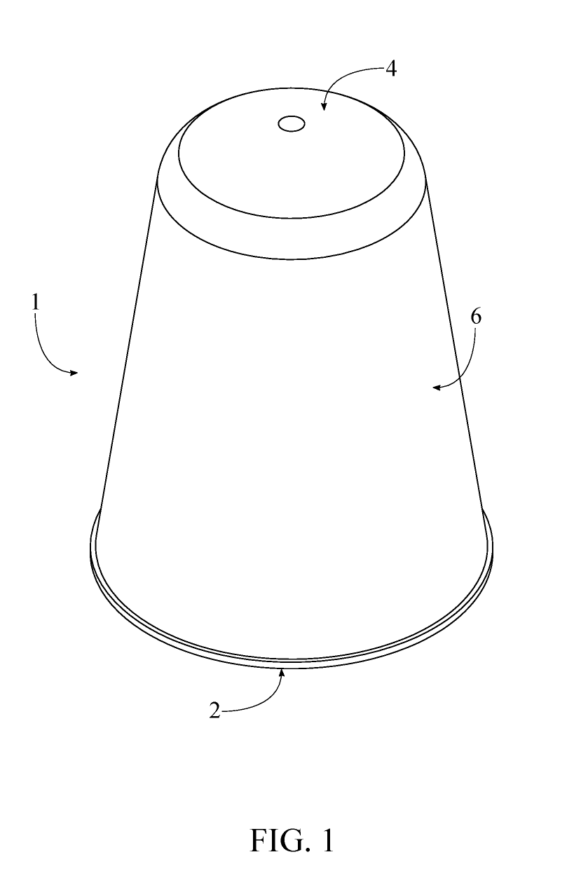

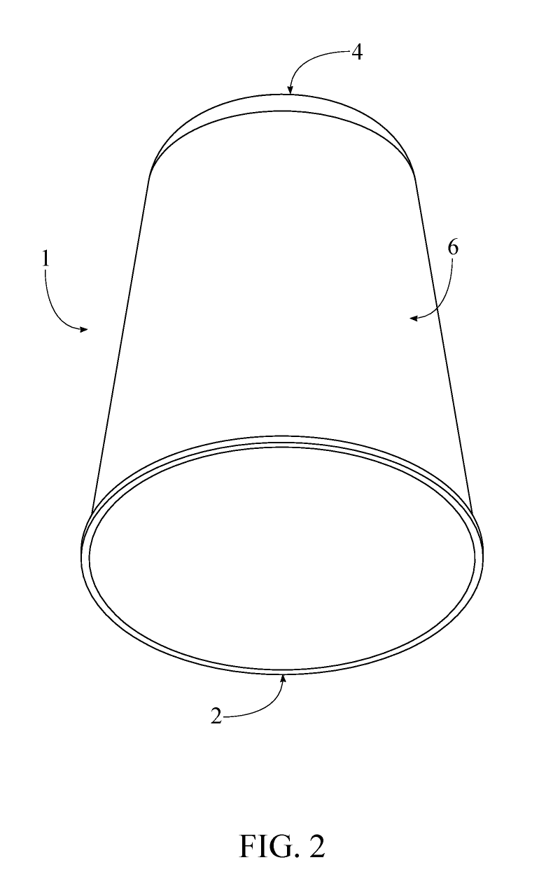

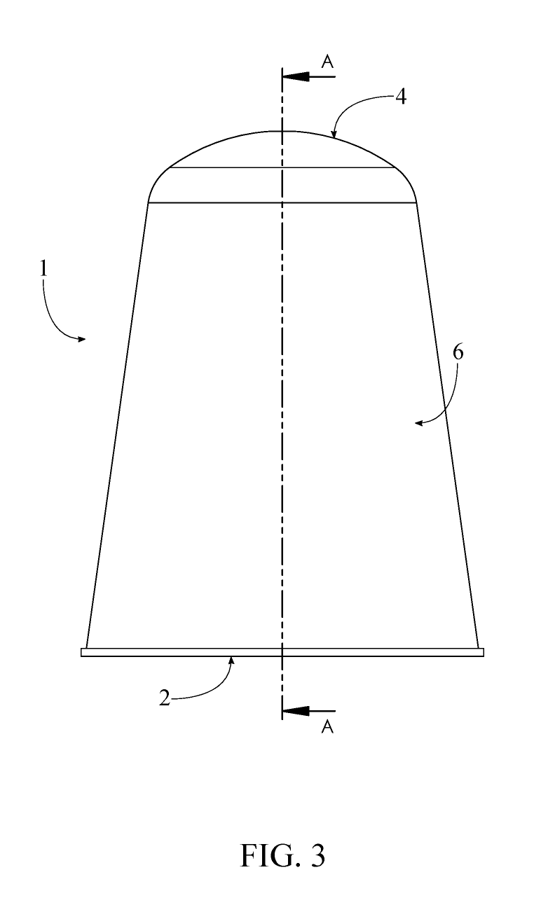

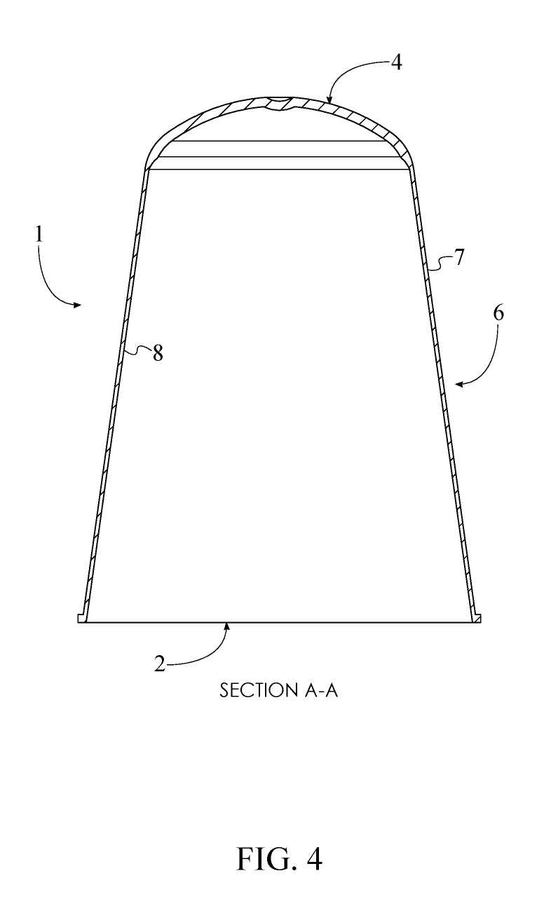

The present invention is a grabbing device for beverage container lids that eliminates the need to physically handle a beverage container lid during preparation of a beverage. The present invention prevents contact between a beverage container lid and a potentially contaminated surface such as skin or a counter surface. The present invention is shown in FIGS. 1-4 and comprises a hollow shell 1.

The hollow shell 1 provides a physical barrier between a beverage container lid and a potentially contaminated surface. The hollow shell 1 is utilized to hold as well as place a lid onto a beverage container. In the preferred embodiment of the present invention, the hollow shell 1 is grasped and lowered onto a stack of beverage container lids in order to secure at least one beverage container lid within the hollow shell 1. The hollow shell 1 comprises an open end 2, a closed end 4, and a lateral portion 6.

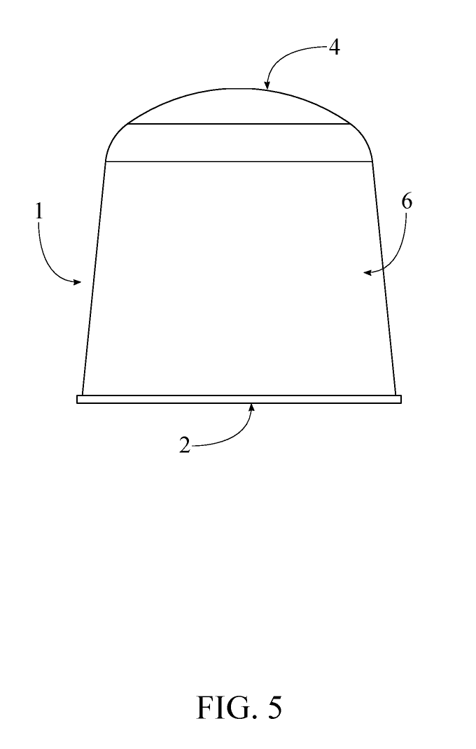

The open end 2 and the closed end 4 are opposing ends of the hollow shell 1. The open end 2 is the end that is lowered onto the beverage container lids and allows at least one beverage container lid to enter the interior of the hollow shell 1. In the preferred embodiment of the present invention, the closed end 4 is concave and as such, the user may hold the hollow shell 1 by cupping his or her palm over the closed end 4. The lateral portion 6 forms the main body of the hollow shell 1 and is connected in between the open end 2 and the closed end 4. The lateral portion 6 may thus be grasped by the user when the hollow shell 1 is being lowered onto the beverage container lids. The lateral portion 6 comprises an outer annular surface 7 and an inner annular surface 8. The outer annular surface 7 is the outward-facing surface of the lateral portion 6 while the inner annular surface 8 is the inward-facing surface of the lateral portion 6. The outer annular surface 7 is positioned around the inner annular surface 8 and is thus positioned and oriented towards the exterior of the hollow shell 1. The hollow shell 1 is not limited with respect to size and may be larger or smaller as shown in FIG. 5 in order to accommodate different sizes of lids.

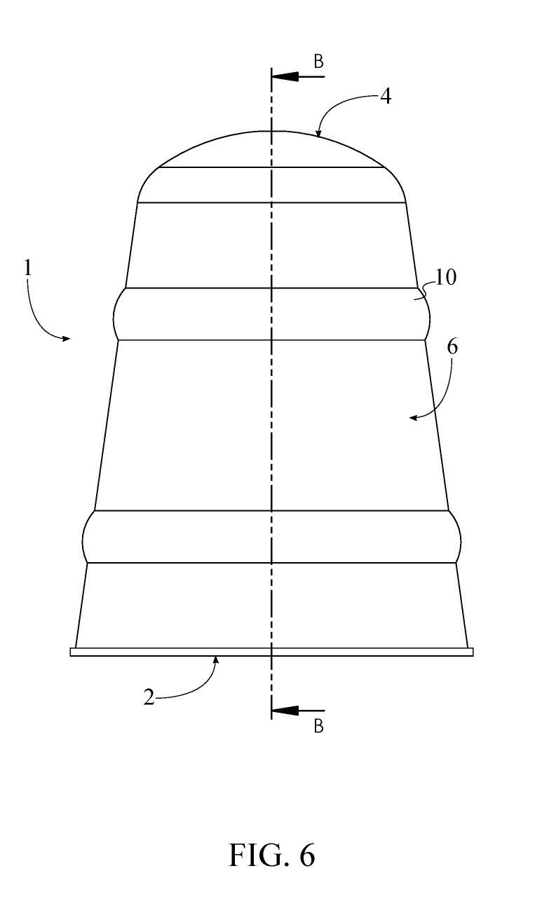

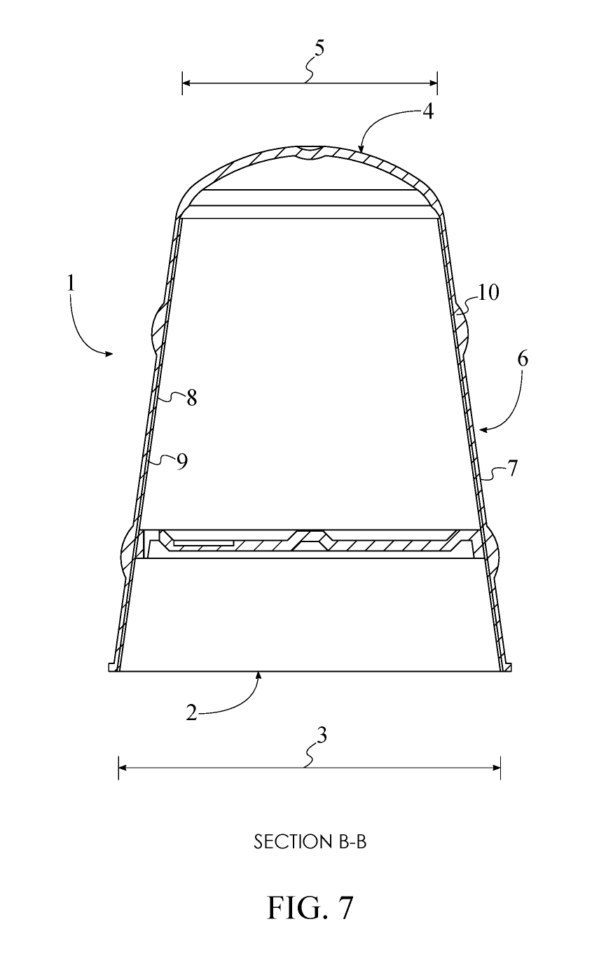

With reference to FIG. 6 and FIG. 7, the present invention may further comprise at least one lid-gripping feature 9 and at least one hand grip 10. The at least one lid-gripping feature 9 is able to assist in retaining at least one beverage container lid within the hollow shell 1. As such, the at least one lid-gripping feature 9 prevents the at least one beverage container lid from falling out of the hollow shell 1 during use of the present invention. The at least one lid-gripping feature 9 is integrated into and about the inner annular surface 8, enabling the at least one lid-gripping feature 9 to come into contact with the at least one beverage container lid when the hollow shell 1 is lowered and pressed onto a stack of beverage container lids. In the preferred embodiment of the present invention, the at least one lid-gripping feature 9 is a rubberized coating. The at least one hand grip 10 increases the ergonomics of the present invention and improves the user's grasp on the hollow shell 1 during use of the present invention. The at least one hand grip 10 is integrated into and about the outer annular surface 7. As such, the at least one hand grip 10 is externally positioned on the hollow shell 1 and the user may easily grasp the hollow shell 1 via the at least one hand grip 10. In the preferred embodiment of the present invention, the at least one hand grip 10 is a rubberized ring that may be frictionally held by the user.

A single lid embodiment of the present invention is shown in FIGS. 1-7. In the single lid embodiment of the present invention, the hollow shell 1 is tapered. A cross-sectional diameter 3 of the open end 2 is greater than a cross-sectional diameter 5 of the closed end 4. This enables a single lid to be secured within the hollow shell 1 when the hollow shell 1 is lowered onto a stack of beverage container lids. The single lid comes into contact with the at least one lid-gripping feature 9 and is held in place via friction.

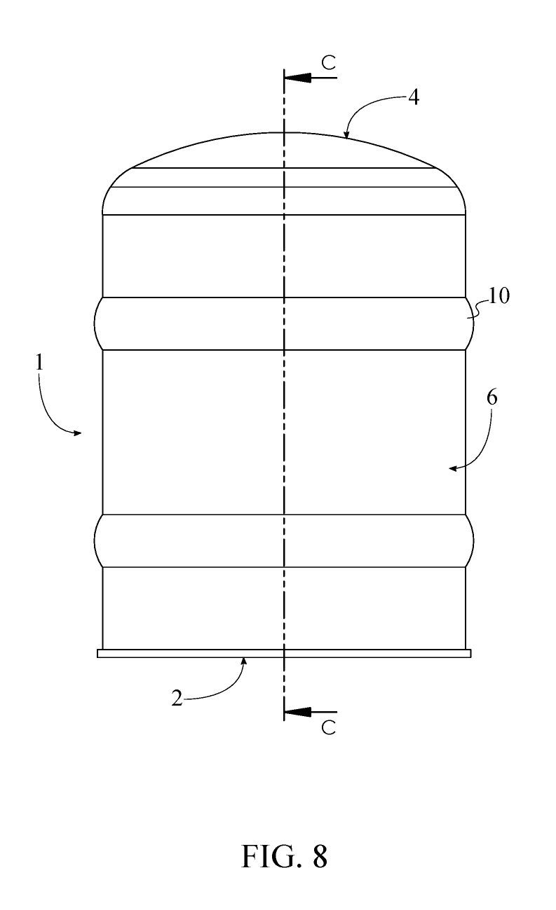

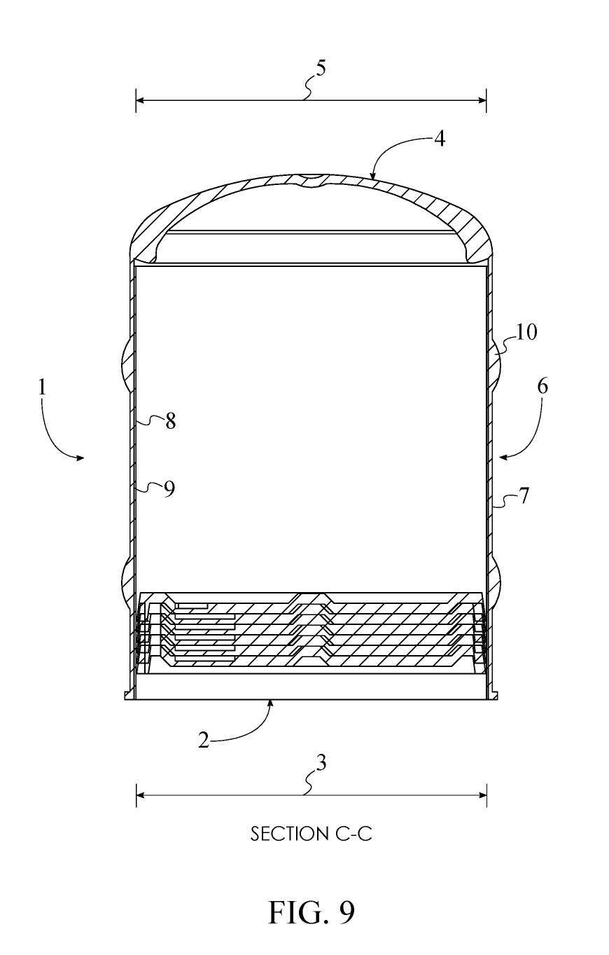

A multiple lid embodiment of the present invention is shown in FIG. 8 and FIG. 9. In the multiple lid embodiment of the present invention, the hollow shell 1 is cylindrical. As a result, the cross-sectional diameter 3 of the open end 2 is equivalent to the cross-sectional diameter 5 of the closed end 4. Multiple lids may thus be secured within the hollow shell 1 when the hollow shell 1 is lowered onto a stack of beverage container lids. The multiple lids remain stacked within the hollow shell 1 and are held in place via friction against the at least one lid-gripping feature 9.

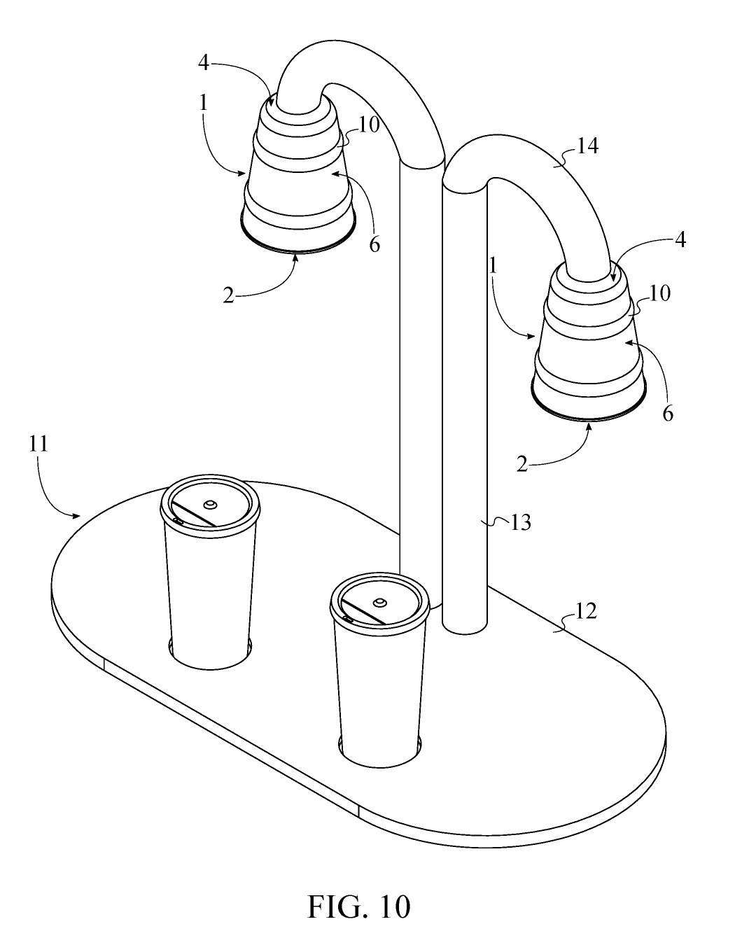

As shown in FIG. 10, the present invention may be utilized in conjunction with a holding stand 11. The holding stand 11 is able to hold the hollow shell 1 when not in use, eliminating the need to place the hollow shell 1 onto a potentially contaminated surface when not in use. The holding stand 11 comprises a stabilizing base 12, at least one support member 13, and at least one holding member 14. The stabilizing base 12 provides stability for the holding stand 11 when the holding stand 11 is resting on a surface. The at least one support member 13 is an elongated member that places the hollow shell 1 into an elevated position when the hollow shell 1 is mounted to the holding stand 11. The at least one holding member 14 secures one or more of the present invention in place on the holding stand 11. The at least one support member 13 is connected normal to the holding stand 11 and thus projects upward and away from the surface of the stabilizing base 12. The at least one holding member 14 is removably mounted to the at least one support member 13. This enables the at least one holding member 14 to be removed from the at least one support member 13 and placed onto a refrigerator door or similar surface. The hollow shell 1 is removably engaged to the at least one holding member 14, enabling the hollow shell 1 to be removed from the at least one holding member 14 prior to use and replaced after use.

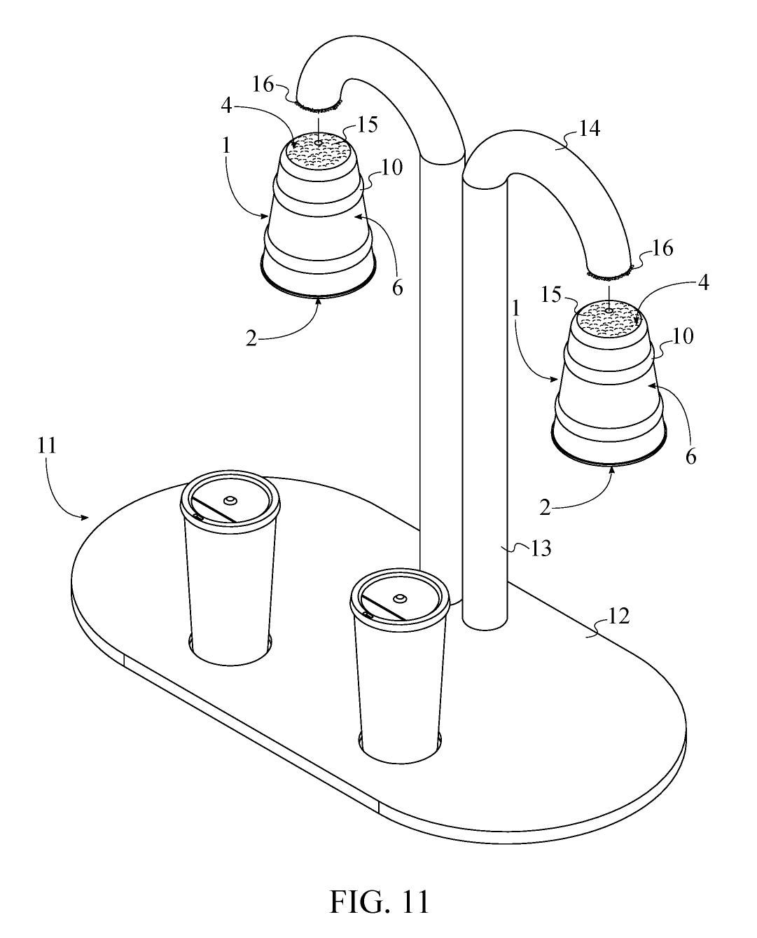

With reference to FIG. 11, a plurality of hook fasteners 15 and a plurality of loop fasteners 16 may be utilized to removably mount the hollow shell 1 to the at least one holding member 14. The plurality of loop fasteners 16 is positioned on the at least one holding member 14 and provides a mounting point on the at least one holding member 14 for the hollow shell 1. The plurality of hook fasteners 15 is externally positioned on the hollow shell 1, allowing the hollow shell 1 to be removably mounted to the at least one holding member 14. The plurality of hook fasteners 15 is removably engaged to the plurality of loop fasteners 16. The hollow shell 1 may thus be easily removed from the at least one holding member 14 before use and replaced after use.

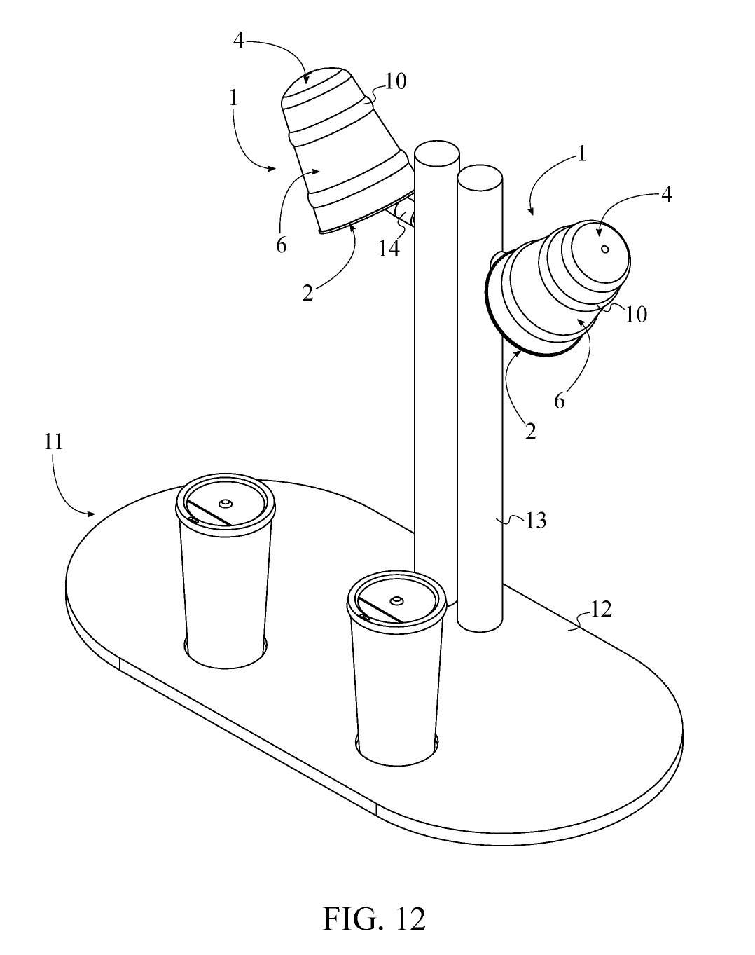

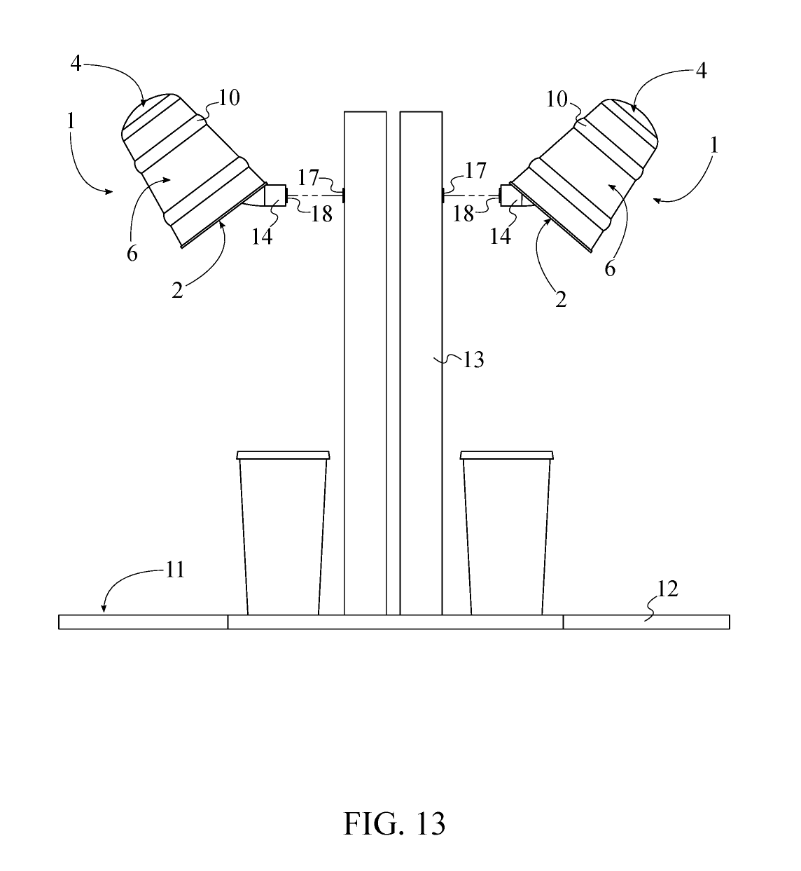

Referring to FIG. 12 and FIG. 13, a first magnet 17 and a second magnet 18 may be utilized to removably mount the at least one holding member 14 to the at least one support member 13. The first magnet 17 is positioned on the at least one support member 13 and provides a mounting point for the at least one holding member 14 on the at least one support member 13. The second magnet 18 is positioned on the at least one holding member 14 and allows the at least one holding member 14 to be removably mounted to the at least one support member 13. The first magnet 17 is removably engaged to the second magnet 18. As such, the at least one holding member 14 may be easily attached to and removed from the at least one support member 13 as needed.

Although the present invention has been explained in relation to its preferred embodiment, it is understood that many other possible modifications and variations can be made without departing from the spirit and scope of the present invention as hereinafter claimed.

What is claimed is:

1. A grabbing device for beverage container lids comprises:
a hollow shell;
the hollow shell comprises an open end, a closed end, and a lateral portion;
the lateral portion comprises an outer annular surface and an inner annular surface;
the lateral portion being connected in between the open end and the closed end; and
the outer annular surface being positioned around the inner annular surface.

2. The grabbing device for beverage container lids as claimed in claim 1, wherein the closed end is concave.

3. The grabbing device for beverage container lids as claimed in claim 1 further comprises:
at least one lid-gripping feature;
at least one hand grip;
the at least one lid-gripping feature being integrated into and about the inner annular surface; and
the at least one hand grip being integrated into and about the outer annular surface.

4. The grabbing device for beverage container lids as claimed in claim 3, wherein the at least one lid-gripping feature is a rubberized coating.

5. The grabbing device for beverage container lids as claimed in claim 3, wherein the at least one hand grip is a rubberized ring.

6. The grabbing device for beverage container lids as claimed in claim 1 further comprises:
the hollow shell being tapered; and
a cross-sectional diameter of the open end being greater than a cross-sectional diameter of the closed end.

7. The grabbing device for beverage container lids as claimed in claim 1 further comprises:
the hollow shell being cylindrical; and
a cross-sectional diameter of the open end being equivalent to a cross-sectional diameter of the closed end.

8. A system for the grabbing device for beverage container lids as claimed in claim 1 comprises:
a holding stand;
the holding stand comprises a stabilizing base, at least one support member, and at least one holding member;
the at least one support member being connected normal to the holding stand;
the at least one holding member being removably mounted to the at least one support member; and
the hollow shell being removably engaged to the at least one holding member.

9. The system for the grabbing device for beverage container lids as claimed in claim 8 further comprises:
a plurality of hook fasteners;
a plurality of loop fasteners;
the plurality of loop fasteners being positioned on the at least one holding member;
the plurality of hook fasteners being externally positioned on the hollow shell; and
the plurality of hook fasteners being removably engaged to the plurality of loop fasteners.

10. The system for the grabbing device for beverage container lids as claimed in claim 8 further comprises:
a first magnet;
a second magnet;
the first magnet being positioned on the at least one support member;
the second magnet being positioned on the at least one holding member; and
the first magnet being removably engaged to the second magnet.
